(19) United States
(12) Patent Application Publication
(10) Pub. No.: US 2010/0032453 A1
(43) Pub. Date: Feb. 11, 2010

(54) Fluid dispenser

(76) Inventors: Simon Lacasse, St-Hubert (CA); Yannick Dagenais, St-Hubert (CA)

Correspondence Address: INVENTION QUEBEC INC., 8065, BOUL. VIAU SUITEE 202, MONTREAL, QC, H1R 2T2, CA

(21) Appl. No.: 12/320,396

(22) Filed: Jan. 26, 2009

(30) Foreign Application Priority Data
Jan. 24, 2008 (GB) 0801249.4

(51) Int. Cl. B67D 7/58

(52) U.S. Cl. 222/380

(57) ABSTRACT

A fluid dispenser for dispensing a fluid, the fluid dispenser comprising: a main body, the main body defining a fluid reservoir for containing the fluid; a measuring reservoir; an output nozzle for selectively dispensing said fluid contained in said measuring reservoir; a valve in fluid communication with the fluid reservoir, the measuring reservoir and the output nozzle, the valve being configurable between a measuring configuration in which the fluid and measuring reservoirs are in fluid communication with each other and a dispensing configuration in which the measuring reservoir and the output nozzle are in fluid communication with each other; a piston mounted inside the measuring reservoir for reciprocating movement relative thereto between a piston first position and a piston second position, the piston substantially sealingly engaging the measuring reservoir; a piston actuator operatively coupled to the piston for moving the piston relative to the measuring reservoir between the piston first and second positions, the piston actuator including an actuating arm pivotally mounted to the main body so as to be pivotable between an arm first position and an arm second position, the actuating arm being operatively coupled to the piston such that when the actuating arm is in the arm first position, the piston is in the piston first position, and when the actuating arm is in the arm second position, the piston is in the piston second position; and a valve actuator for selectively configuring the valve between the dispensing and measuring configurations.

### FIELD OF THE INVENTION

The present invention relates generally to fluid dispensers and, more particularly, to a manually operated fluid dispenser.

### BACKGROUND

Fluid dispensers for dispensing measured amounts of viscous fluids such as, for example, gel-like materials, cream, paste, or the like, are known in the art and are particularly useful for dispensing metered amounts of fluids used in the preparation of coloring chemicals commonly used in the field of dyeing hair applications such as, for example, hydrogen peroxide and hair coloring pigments.

Fluid dispensers of the prior art generally consist of a main fluid reservoir in fluid communication, through a two-way valve, with a measuring cylinder equipped with a manually or computer operated plunger or piston. In use, the two-way valve is positioned in a first position such that a metered amount of fluid can be withdrawn from the reservoir and transferred to the measuring cylinder using a vacuum induced force created by actuating the piston in a first direction within the cylinder. The two-way valve is then moved in a second position and the piston actuated in an opposite direction such that a positive mechanical pressure forces the metered amount of fluid in the cylinder out through an output port and into a receiving cup or the like.

Typical examples of the prior art are U.S. Pat. No. 4,781,312, to Strazdins (1988), U.S. Pat. No. 5,356,041, to Hellenberg et Al. (1994), U.S. Pat. No. 6,003,731, to Post et Al. (1999), U.S. Pat. No. 6,089,408, to Fox (2000), U.S. Pat. No. 6,811,058 B2, to Voskuil et Al. (2004), and U.S. Pat. No. 6,945,431B2, to Miller (2005).

While these prior art devices generally offer a fluid dispenser for measuring and dispensing viscous fluids, they also entail one or more of the following disadvantages. First, the manually operated fluid dispensers are generally equipped with a piston or plunger extension rod that is directly operated by hand and, thus, requires relatively good manual dexterity to precisely position the piston or plunger at level with volumetric scale markings along the measuring cylinder, an operation which can be a challenge due to the viscous nature of the fluid and which often leads to errors.

Also, the outlet port of the two-way valve is generally not equipped with means to avoid the drying of fluid in and around the port. Therefore, cleaning operations have to be performed at timed intervals.

Finally, the fluid dispensers able to deliver precise metered volume of fluids are generally computer operated and, thus, are complex and expensive to manufacture, and generally require specially trained personnel to configure and operate, as well as to perform other operations such as priming and maintenance procedures.

Against this background, there exist a need for a new and improved fluid dispenser that avoids the aforementioned disadvantages.

### SUMMARY OF THE INVENTION

In a broad aspect, the invention provides a fluid dispenser for dispensing a fluid, the fluid dispenser comprising: a main body, the main body defining a fluid reservoir for containing the fluid; a measuring reservoir; an output nozzle for selectively dispensing said fluid contained in said measuring reservoir; a valve in fluid communication with the fluid reservoir, the measuring reservoir and the output nozzle, the valve being configurable between a measuring configuration in which the fluid and measuring reservoirs are in fluid communication with each other and a dispensing configuration in which the measuring reservoir and the output nozzle are in fluid communication with each other; a piston mounted inside the measuring reservoir for reciprocating movement relative thereto between a piston first position and a piston second position, the piston substantially sealingly engaging the measuring reservoir; a piston actuator operatively coupled to the piston for moving the piston relative to the measuring reservoir between the piston first and second positions, the piston actuator including an actuating arm pivotally mounted to the main body so as to be pivotable between an arm first position and an arm second position, the actuating arm being operatively coupled to the piston such that when the actuating arm is in the arm first position, the piston is in the piston first position, and when the actuating arm is in the arm second position, the piston is in the piston second position; and a valve actuator for selectively configuring the valve between the dispensing and measuring configurations.

In some embodiments of the invention, the valve actuator includes an actuator handle that provides leverage in operation of the piston. Therefore, a relatively large movement of the actuator handle results in a relatively small movement of the piston, which facilitates a relatively precise measurement of the volume of fluid to dispense. Also, the leverage helps in reducing the force needed to move the fluid in the fluid dispenser, which is particularly advantageous for relatively viscous fluids.

In some embodiments of the invention, the valve is biased towards the measuring configuration. Once again, this facilitates operation of the proposed fluid dispenser as the piston can be moved inside the measuring reservoir until a precise volume measurement is achieved without risk of accidental dispensing of the fluid. Therefore, in some embodiments of the invention, the proposed fluid dispenser is relatively easily operable in a series of quick and ergonomic steps.

In some embodiments of the invention, the output nozzle is a self-closing output nozzle including a one-way check valve that greatly reduces the drying of residual fluid within the output port of the valve or leakage through the output nozzle when the fluid dispenser is not in frequent use;

In some embodiments of the invention, the proposed fluid dispenser is relatively simple and economical to produce and can be relatively easily dismantled for cleaning, maintenance and refilling of the fluid reservoir.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1, in a front elevational view, illustrates a fluid dispenser according to an embodiment of the present invention, here shown with an actuating handle thereof in a lowered position;

FIG. 2, in a side elevational view, illustrates the fluid dispenser shown in FIG. 1;

FIG. 3, in a front elevational view, illustrates the fluid dispenser shown in FIGS. 1 and 2, the fluid dispenser being shown with a housing cover thereof removed and the actuating handle in the lowered position;

FIG. 4, in a side elevational view, illustrates the fluid dispenser shown in FIGS. 1 to 3, the fluid dispenser being shown with a housing cover thereof removed and the actuating handle in the lowered position;

FIG. 5, in a front elevational view, illustrates the fluid dispenser shown in FIGS. 1 to 4, the fluid dispenser being shown with the housing cover thereof removed and the actuating handle in a raised position;

FIG. 6, in a side elevational view, illustrates the fluid dispenser shown in FIGS. 1 to 5, the fluid dispenser being shown with a housing cover thereof removed and the actuating handle in the raised position;

FIG. 7A, in a cross-sectional view taken along section line 7A-7A of FIG. 1A, illustrates the fluid dispenser shown in FIGS. 1 to 6;

FIG. 7B, in a partial cross-sectional view taken along section line 7A-7A of FIG. 1, illustrates a valve of the fluid dispenser shown in FIGS. 1 to 7A;

FIG. 8, in a bottom perspective view, illustrates an output nozzle of the fluid dispenser shown in FIGS. 1-7B;

FIG. 9, in a side elevational view, illustrates the output nozzle shown in FIG. 8;

FIG. 10, in a bottom plan view, illustrates the output nozzle shown in FIGS. 8 and 9;

FIG. 11A, in a cross-sectional view taken along section line 11A-11A in FIG. 9, illustrates the output nozzle shown in FIGS. 8 to 10 in a closed configuration;

FIG. 11B, in a cross-sectional view taken along section line 11A-11A in FIG. 9, illustrates the output nozzle shown in FIGS. 8 to 11A in an open configuration;

FIG. 12A, in a side cross-sectional view, illustrates a first step in operating the fluid dispenser shown in FIGS. 1 to 7A.

FIG. 12B, in a partial side cross-sectional view, illustrates the first step in operating the fluid dispenser shown in FIGS. 1 to 7A.

FIG. 12C, in a side cross-sectional view, illustrates a second step in operating the fluid dispenser shown in FIGS. 1 to 7A.

FIG. 12D, in a partial side cross-sectional view, illustrates the second step in operating the fluid dispenser shown in FIGS. 1 to 7A.

FIG. 12E, in a side cross-sectional view, illustrates a third step in operating the fluid dispenser shown in FIGS. 1 to 7A.

FIG. 12F, in a partial side cross-sectional view, illustrates the third step in operating the fluid dispenser shown in FIGS. 1 to 7A.

FIG. 13, in a side elevational view, illustrates a stand for supporting the fluid dispenser shown in FIGS. 1 to 7B, the fluid dispenser being shown detached from the stand;

FIG. 14, in a side elevational view, illustrates a stand for supporting the fluid dispenser shown in FIGS. 1 to 7B, the fluid dispenser being shown detached from the stand;

FIG. 15, in a top elevational view, illustrates a fluid reservoir of the fluid dispenser shown in FIGS. 1 to 7B, the fluid reservoir including a vent hole provided; and

FIG. 16, in a side cross-sectional view, illustrates the vent hole shown in FIG. 15.

### DETAILED DESCRIPTION

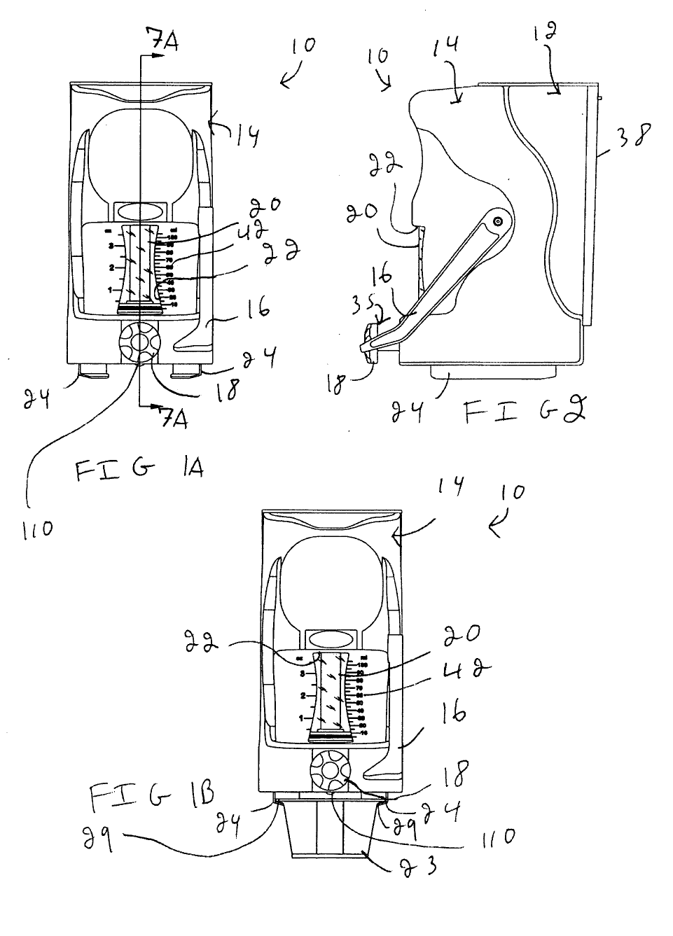

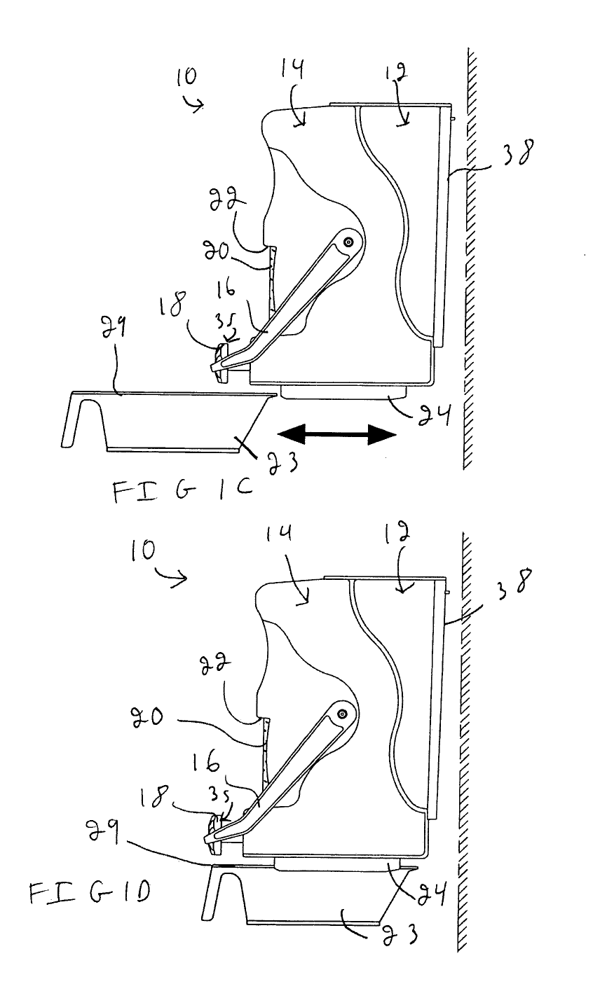

FIGS. 1A, 1B and 2 best show various aspects of an embodiment of the fluid dispenser 10 according to the present invention. The fluid dispenser 10 is typically formed from plastic injection moulded components and generally comprises a main body 12, a removable housing cover 14, an actuating handle 16, a dispensing valve actuating push knob 18, a typically transparent measuring reservoir 20, visually accessible through a window 22 in the front end portion of the housing cover 14, and a pair of oppositely disposed receiving cup support rails 24 underlying the fluid dispenser 10. An output nozzle 110 (not seen in FIG. 2) is also provided for selectively dispensing a measured fluid from the measuring reservoir.

In the present document, directional terminology such as top, bottom, front and rear is used, this terminology referring to the typical orientation of the proposed fluid dispenser 10 when in use. This terminology is used only for clarity reasons and should not be used to restrict the scope of the appended claims.

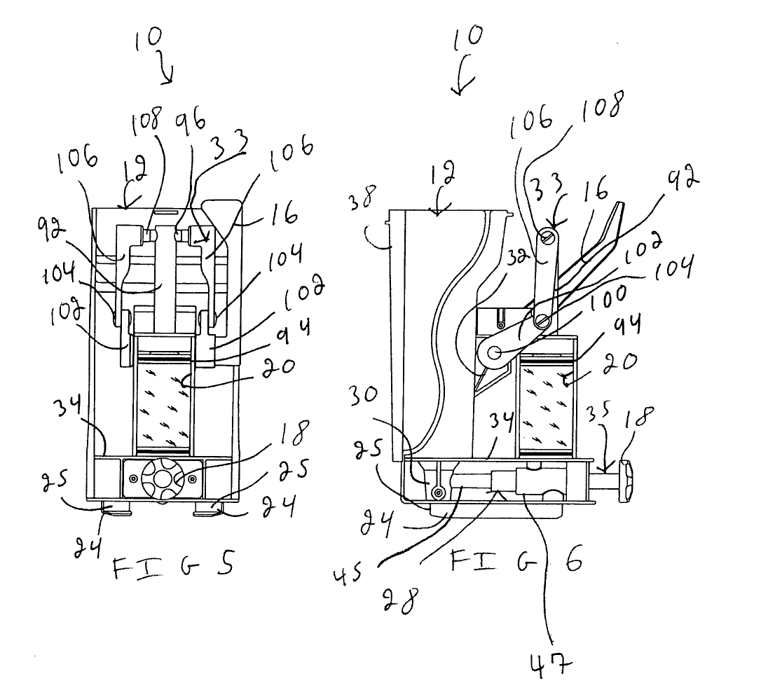

FIGS. 4 and 7A best show main body 12 defining a fluid reservoir 26 that is substantially defining the rear end portion of the main body 12, a valve housing 28 laterally extending from the lower end portion 30 of the fluid reservoir 26, a pivot support 32 laterally extending from a front end, mid-portion of the fluid reservoir 26, for pivotally supporting a piston actuator 33, which will be described in details hereinafter, and a base support portion 34 that generally encompasses and structurally reinforces the lower end portion 30 of the fluid reservoir 26 with valve housing 28. The receiving cup support rails 24 are substantially parallel to each other and substantially longitudinally extending. The receiving cup support rails 24 are downwardly protruding from the underside of the lower end portion 30.

The elongated receiving cup support rails 24 have symmetrically opposed L-shaped cross-sections to allow a compatibly shaped receiving cup 23 (seen in FIG. 1B for example), having laterally extending support shoulders 29, to be slidably inserted therebetween. An end wall 25 closes the distal rear end of the receiving cup support rails 24, thus limiting the insertion of the receiving cup 23 to a preferred position. It is to be understood that the receiving cup support rails 24 may be shaped and sized to suit any other receiving cup configuration. Also, in alternative embodiments of the invention, the fluid dispenser 10 defines any other suitable receiving cup support for supporting the receiving cup 23.

The valve housing 28 is part of a valve 35 that is in fluid communication with the fluid reservoir 26, the measuring reservoir 20 and the output nozzle 110. The valve 35 is configurable between a measuring configuration in which the fluid and measuring reservoirs 26 and 20 are in fluid communication with each other and a dispensing configuration in which the measuring reservoir 20 and the output nozzle 110 are in fluid communication with each other.

As with conventional mass products of comparable size, the main body 12 described above is typically formed as a one piece element using a conventional plastic injection molding process. It is to be understood that main body 12 can as well be manufactured from an equivalent assembly of individual components.

Furthermore, in a some embodiments of the invention, as seen for example in FIG. 2, the rear end portion 38 of the fluid reservoir 26 is compatibly sized and shaped to be removably anchored onto a dedicated table-top or wall mounted support element designed to accommodate one or a plurality of fluid dispensers 10, and which leaves an adequate obstruction free access space underlying the fluid dispensers 10 to allow the receiving cup 23 to be slid between the receiving cup support rails 24.

The housing cover 14 substantially covers the front and sides of the fluid dispenser 10, up to the main body 12. The housing cover 14 has a substantially rectangular window 22 centrally provided therethrough for allowing a user to see the content of the measuring reservoir 20, which has typically a generally upstanding cylindrical shape that is substantially closely abutting against the inner surrounding surface of the window 22, which is located substantially in register with the measuring reservoir 20. Typically, the window 22 takes the form of an aperture extending through the housing cover 14.

As seen in FIGS. 1A and 1B, a plurality of indicia such as, for example, volumetric scale markings 42 indicated in imperial and/or metric units are provided for indicating a volume of fluid received in the measuring reservoir 20. For example, volumetric scale markings 42 are vertically ranged on either sides of the window 22. The measuring reservoir 20 and the usage of the volumetric scale markings 42 will be described in more details hereinafter.

FIG. 7A shows the fluid reservoir 26 generally defined by a fluid reservoir compartment 44 having an open upper end 46 and a funnel-like lower end portion 30. Upper end 46 is closed with a removable lid 48 provided with a recessed handle 49 and at least one vent hole 130 (described in further details hereinbelow and illustrated, for example, in FIG. 15) for maintaining air pressure equilibrium between the inside of the fluid reservoir 26 and the ambient atmospheric air.

Now referring to FIGS. 6, 7A and 7B, projecting frontwardly from the funnel-like lower end portion 30 of the fluid reservoir 26 is the valve housing 28 which is generally represented by an elongated, substantially cylindrical body comprising an intake port portion 45 at a distal end, the intake port portion 45 being in fluid communication with the fluid reservoir 26, and a valve stem housing portion 47 at a proximal end, the valve stem housing portion 47 being in fluid communication with the intake port portion 45. As better seen in FIG. 7B, from the valve stem housing portion 47, an upwardly oriented measuring reservoir port 51 and a downwardly oriented output port 53 extend, both being in fluid communication with the valve stem housing portion 47. The output nozzle 110 is sealably affixed to the distal end of output port 53.

Typically, the fluid reservoir 26 and the measuring reservoir 20 extend in a substantially parallel and substantially spaced apart relationship relatively to each other and the valve housing therefore protrudes away from the measuring reservoir and lead to the output nozzle 110.

Valve stem housing portion 47 is configured for slidably and sealably receiving a valve stem 52 defining an elongated stem inner portion 54 received in the valve stem housing portion 47 and a stem outer portion 56 extending therefrom and protruding from the valve stem housing portion 47. The stem inner portion 54 is provided with substantially axially spaced apart distal and proximal rings 58 and 60 that each extend substantially radially from said stem inner portion 54, each having a circumferential groove adapted to receive an annular gasket seal, or O-ring 62 for sealingly engaging the valve housing 28. An axially aligned bore 66, provided through a removable abutment end plate 68 that is closing the proximal end of the valve housing 28, allows for the stem outer portion 56 to extend exteriorly of the valve housing 28. The stem inner portion 54 and stem outer portion 56 may include a hollow tubular body closed at a distal end 64 and threadedly connected to a valve actuator, such as for example the push knob 18 at its proximal end, as best illustrated in FIG. 7A. The push knob 18 is usable for selectively configuring the valve 35 between the dispensing and measuring configurations. Abutment end plate 68 is removably affixed to the proximal end of the valve housing 28 through suitable fastening means such as a pair of screws positioned on each side of push knob 18.

The stem inner portion 54, including the distal and proximal rings 58 and 60, is allowed a coaxial movement within the valve stem housing portion 47 that is extending between abutment end plate 68 and an annular abutment shoulder 70 provided at a location intermediate the intake port portion 45 and the measuring reservoir port 51. Annular abutment shoulder 70 is sufficiently distanced from the adjacent measuring reservoir port 51 such that the distal ring 58 does not obstruct the measuring reservoir port 51 when abutting against the abutment shoulder 70. Therefore, the valve stem 52 is movable along the valve housing 28 to configure the valve 35 between the measuring and dispensing configurations, the distal ring 58 sealing the output port 53 from the intake port portion 45 and measuring reservoir port 51 when the valve 35 is in the measuring configuration, the distal ring 58 sealing the intake port from the output and measuring reservoir ports 53 and 51 when the valve 35 is in the dispensing configuration.

The distal end 64 of the stem inner portion 54 provides an engaging abutment means against which bears the proximal end of a biasing element, such as an helical spring 72 for biasing the valve stem 52 away from the intake port portion 45, and therefore biasing the valve 35 toward the measuring configuration. The opposite end of the helical spring 72 bears against a distal annular shoulder 74 axially configured at the adjoining edge between the valve stem housing portion 47 and the intake port portion 45. In a relaxed state, helical spring 72 is relatively longer than the distance separating the distal annular shoulder 74 and the distal end 64 of the stem inner portion 54 when the latter is at its most distanced position from distal annular shoulder 74. Therefore, the helical spring 72 tends to hold the stem inner portion 54 against the abutment end plate 68 closing the proximal end of the valve housing 28.

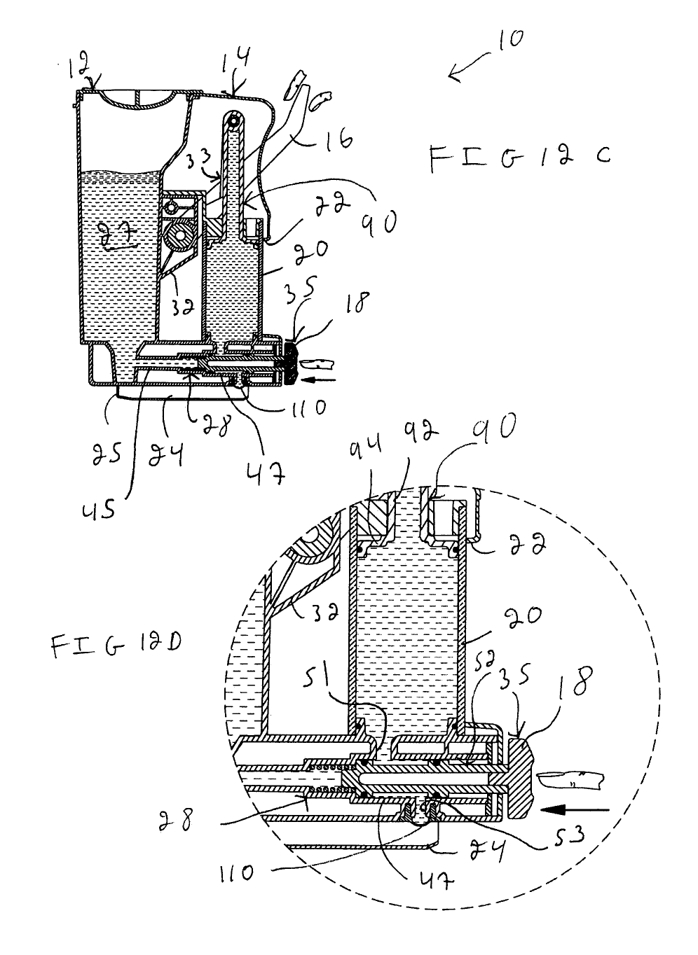

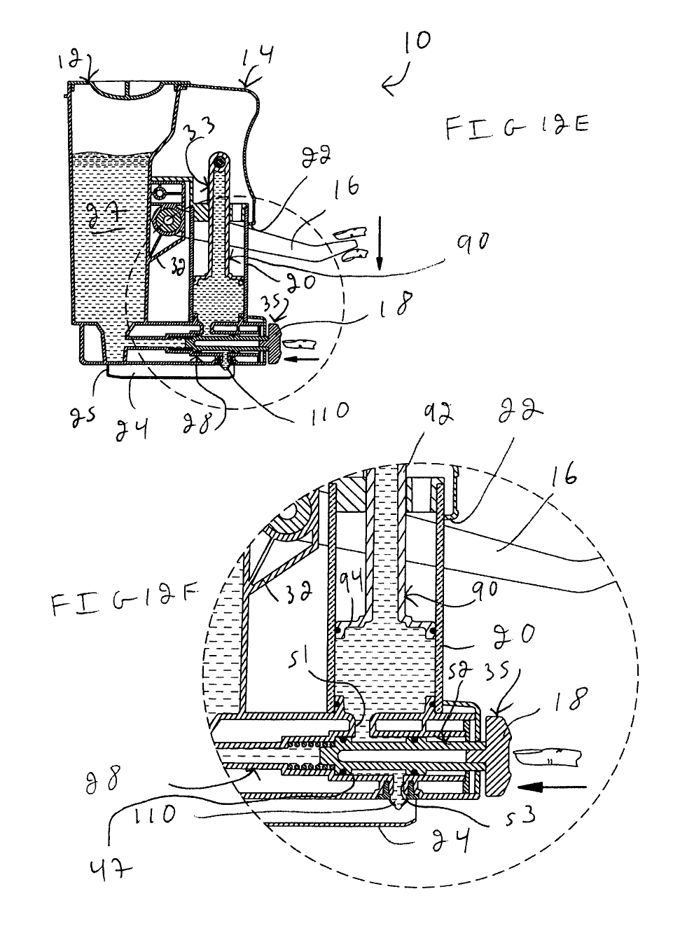

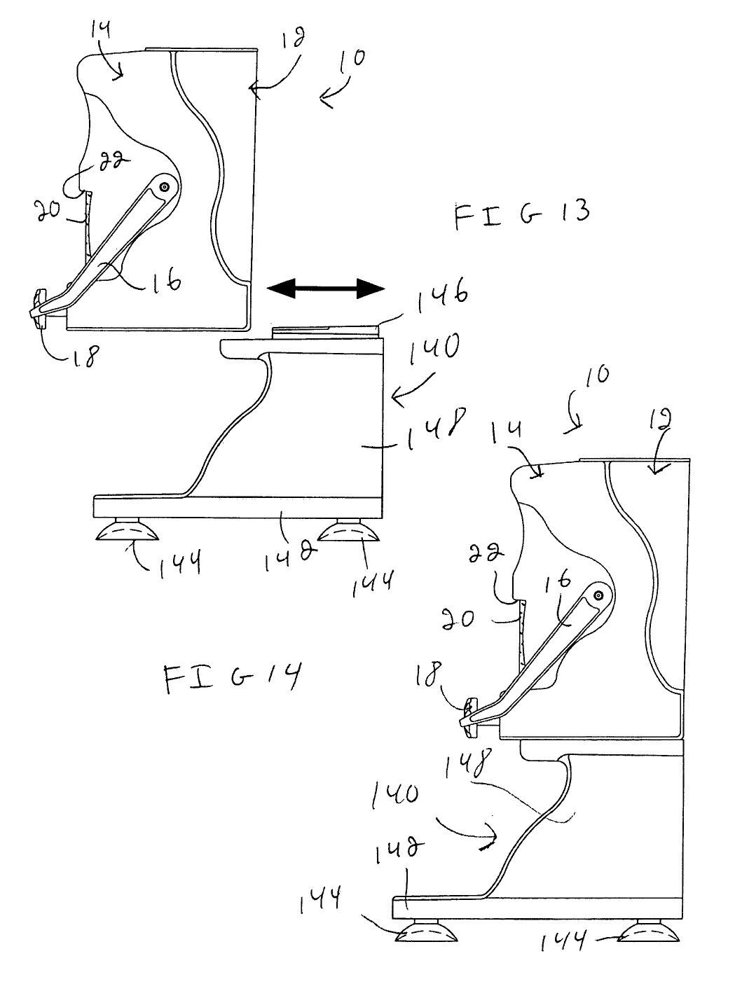

As can be readily appreciated, when there is no force applied on the push knob 18, the measuring reservoir port 51 is in exclusive fluid communication with fluid reservoir 26 through the passageway provided by the valve housing 28, as best illustrated in FIGS. 7A and 12A. Alternatively, when the push knob 18 is fully pushed-in, such that the distal ring 58 of the stem inner portion 54 abuts against the annular abutment shoulder 70, the measuring reservoir port 51 is in exclusive fluid communication with output port 53 through the circumscribed passageway created within the valve stem housing portion 47, between the distal and proximal rings 58 and 60 and around the reduced diameter of the stem inner portion 54 separating the distal and proximal rings 58 and 60, as best illustrated in FIGS. 12C and 12E.

Measuring reservoir 20 is preferably made of a transparent material such as, for example, a clear plastic, for allowing a user to visually assess the level of fluid present in the measuring reservoir 20. FIG. 7B best shows measuring reservoir 20 having its lower end sealably engaged in a snug-fit relationship around an upwardly protruding annular ring 76 extending from the base support portion 34. Annular ring 76 is in fluid communication with measuring reservoir port 51 of the valve housing 28, and is further provided with a circumferential groove accommodating a sealing O-ring 77.

As seen in FIG. 7A, the upper end of measuring reservoir 20 is rigidly fastened to the pivot support 32, extending laterally from the fluid reservoir 26, through a combination bracket 78 including an annular plug-type element 80 axially inserted in a tight-fit relation within the upper end of measuring reservoir 20, and from which is upwardly and rearwardly extending an L-shaped bracket extension member 82 whose horizontal portion comes abutting on a top portion of the pivot support 32. The horizontal portion of the L-shaped bracket extension member 82 may be removably affixed to the pivot support 32 using any suitable fastening means such as, for example, manually releasable clips, thumb screws, conventional screws, or the like.

A piston 90 is mounted inside the measuring reservoir 20 for reciprocating movement relative thereto between a piston first position, seen in FIG. 12A, and a piston second position, seen in FIG. 12C, the piston substantially sealingly engaging the measuring reservoir 20. As better seen in FIG. 7B, the piston 90 defines a piston rod 92 and a piston head portion 94 extending therefrom.

Referring to FIG. 7A, the plug-type element 80 is provided with a substantially centrally located bore 84 for slidably receiving the piston rod 92. Furthermore, the plug-type element 80 is provided with a suitably sized vent hole 86 for allowing a free movement of the piston 90 without creating obstructive pressure or vacuum built-up within the measuring reservoir 20, between the piston head portion 94 and the plug-type element 80.

The piston rod 92 is provided with a piston pivot support 96 located outside of the measuring reservoir 20, and is terminated at the a piston head portion 94, whose cylindrical outer surface is provided with a circumferential groove for receiving therein a sealing O-ring 98. The piston pivot support 96 is for pivotally connecting the piston 90 to the piston actuator 33, which will be described hereinafter, the piston actuator 33 being operatively coupled to the piston 90 for moving the piston 90 relative to the measuring reservoir 20.

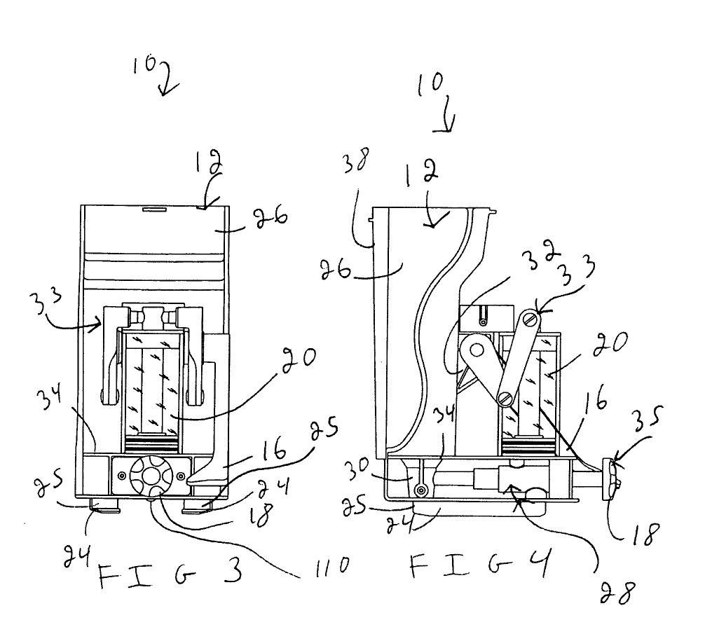

FIGS. 5 and 6 best illustrate the piston actuator 33 comprising the actuating handle 16 having one end rigidly coupled to one end of a first transverse pivot shaft 100 (seen in FIG. 6 only) which, in turn, is pivotally mounted through the pivot support 32 frontwardly extending from the front end portion of the fluid reservoir 26. Additionally to actuating handle 16, a pair of actuating arms 102 are also rigidly radially extending from transverse pivot shaft 100 in a substantially parallel configuration on each side of pivot support 32. Therefore, the actuating handle 16 and the actuating arm 102 are substantially jointly pivotable about the pivot support 32. Each actuating arm 102 is pivotable between an arm first position and an arm second position, each actuating arm 102 being operatively coupled to the piston 90 such that when each actuating arm 102 is in the arm first position, the piston 90 is in the piston first position, and when each actuating arm 102 is in the arm second position, the piston 90 is in the piston second position. In other words, the actuating arm 102 is operatively coupled to the piston 90 for moving the piston 90 inside the measuring reservoir 20.

The pair of actuating arms 102 have their distal end provided with a transverse pivot means 104 to which are pivotally coupled a pair of connecting rods 106 which, in turn, are respectively pivotally coupled at each opposite ends of a second transverse pivot shaft 108 which, in turn, has its middle portion pivotally mounted through piston pivot support 96 at the end of piston rod 92. The piston pivot support 96 at each end of the connecting rods 106 are removably coupled and secured to the actuating arms 102 and second transverse pivot shaft 108 respectively with a suitable means such as, for example, plastic screws.

Thus, by manually raising and lowering the actuating handle 16, a relative vertical movement of the piston head portion 94 is executed in coaxial alignment within measuring reservoir 20 due to the guiding means cooperatively represented by the bore 84 of the plug-type element 80 at the upper end of the measuring reservoir 20, and the cylinder 20 itself around piston head portion 94.

It is important to note that the comparatively shorter actuating arms 102, which represent typically a ratio of about ⅓ the length of the actuating handle 16, confers an inversely greater manual precision adjustment of the vertical position of the piston head 94 relative to the volumetric scale markings 42 on the sides of window 22 of housing cover 14.

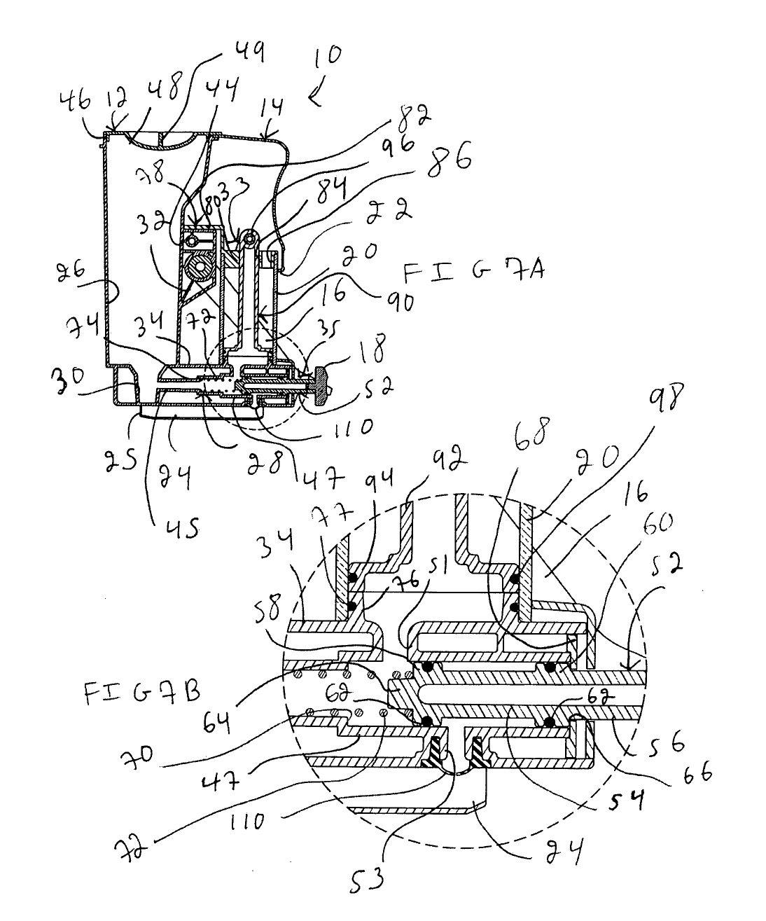

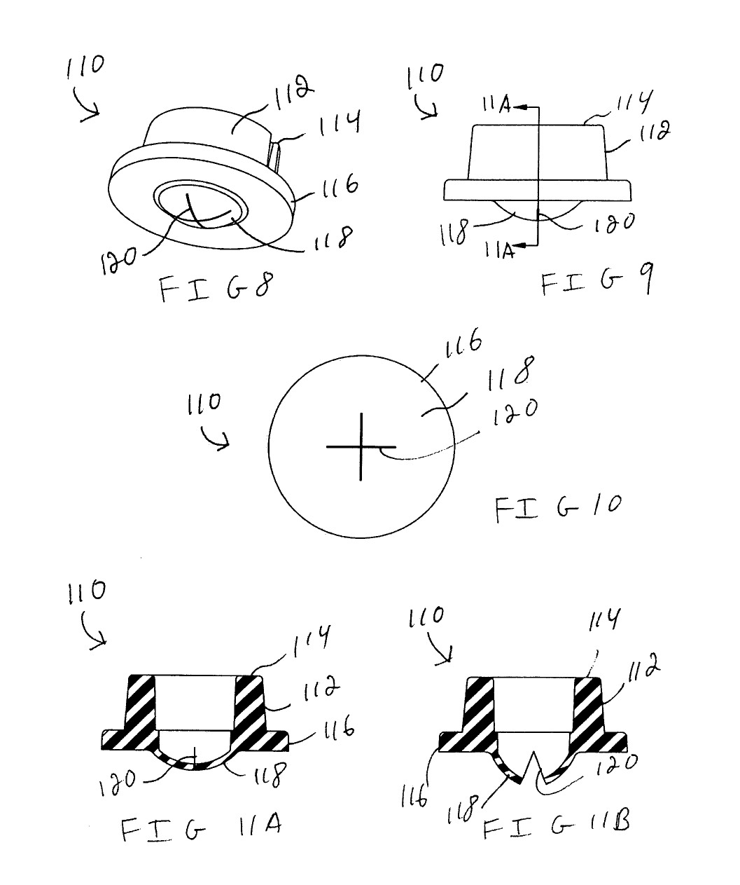

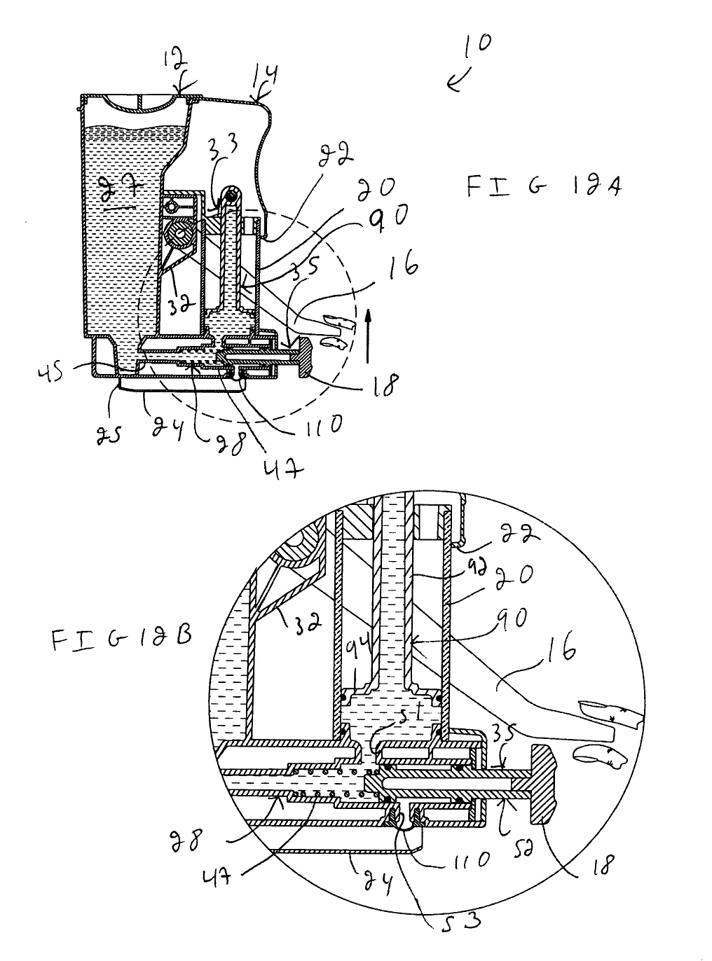

FIGS. 8 to 11B show various aspects of output nozzle 110, which is preferably made of an elastomeric material such as rubber, and can be inexpensively made by a simple extrusion and pressing process. Output nozzle 110 is generally defined by an upstanding and relatively short tubular main body 112 having an open upper end 114, an annular abutment edge 116 surrounding the lower end thereof, and a relatively thin bottom portion 118 slitted with cross-hair cuts 120 which integrally form a pressure sensitive, one-way check valve. In a manner readily apparent to one skilled in the art, and as best illustrated in FIGS. 11A and 11B, the resilient, slitted bottom portion 118 proportionally opens in the presence of sufficient fluid pressure coming through upper end 114 of the output nozzle 110 to let a downflow of fluid, and sealably self-closes when there is not sufficient fluid pressure applied. Output nozzle 110 has its upper end 114 firmly engaged into a correspondingly annular recess generally defining the rigid lower end of output port 53 underlying the valve housing 28, as best illustrated in FIG. 7B.

It is to be noted that the resulting resiliency, derived form the nature and thickness of the elastomeric material forming output nozzle 110, and more specifically with respect to bottom portion 118, is suitably designed to allow the retention of the unmeasured, residual fluid present in the communicating passageways above the closed output nozzle 110, including the content of the valve housing 28 and measuring reservoir 20, when no mechanically forced fluid pressure is applied. Thus, there is no loss of fluid during or after usage of the fluid dispenser 10, only the measured amount of fluid is discharged through the output nozzle 110.

Prior to using the fluid dispenser 10, the fluid reservoir 26 may be filled with at least a sufficient amount of the desired fluid 27, as seen in FIG. 12A, for allowing the fluid dispenser 10 to complete a priming procedure, but is preferably filled to its maximum level. The priming procedure essentially consists in cyclically raising and lowering the actuating handle 16 until there is no more air bubble visibly trapped in the measuring reservoir 20.

Once priming is completed, and a receiving cup 23 or mug equipped with appropriate lateral support shoulders 29 is slided in place between the receiving cup support rails 24 underlying the fluid dispenser 10, the fluid dispenser 10 is ready for normal usage.

FIGS. 12A to 12F illustrate the operating mode of the fluid dispenser 10. In a first step, as illustrated in FIG. 12A, the actuating handle 16 is manually raised until the piston head portion 94, visible in the transparent measuring reservoir 20, through the window 22 of the housing cover 14, is aligned with the desired volumetric scale markings 42 on either sides of window 22. As the piston head portion 94 is raised within the measuring reservoir 20, a vacuum is created therewithin, thus forcing fluid to be withdrawn from the fluid reservoir 26 and transferred into the measuring reservoir 20, through the valve housing 28.

When reaching near the desired level, the user can re-adjust at will the actuating handle 16 in order to have the most accurate alignment between the piston head portion 94 with the desired volumetric scale marking 42 since during this step, the fluid reservoir 26 and the measuring reservoir 20 are kept in a free, bidirectional fluid communication through the valve housing 28.

In a second step, as illustrated in FIG. 12C, the user pushes-in and holds the push knob 18. In a third and final step illustrated in FIG. 12E, the actuating handle 16 is lowered down to its bottom limit. Hence, an accurately measured amount of fluid is poured into the receiving cup 23.

During this final step, it is important to note that the push knob 18 must be kept pushed in to the full extent of its course, and the actuating handle 16 fully lowered down to its lowest position, in order to have an exact equivalent amount of fluid 27 present between the piston head portion 94, and the upper edge of the annular ring 76, as measured at the second step described above, integrally discharged through the output nozzle 110.

Once the actuating handle 16 has reached its lowest position, the push knob 18 can be released, which allows the latter to return to its initial position due to the helical spring 72 in the valve housing 28, and, thus, rendering the fluid dispenser 10 in a ready state for a subsequent use.

It is to be noted that the removable housing cover 14, connecting rods 106, plug-type element 80 and abutment end plate 68 are convenient means through which a user can relatively easily dismantle the piston actuator 33, the measuring reservoir 20 and the valve stem 52 respectively, for facilitating a thorough cleaning and sanitizing procedure of the fluid dispenser 10.

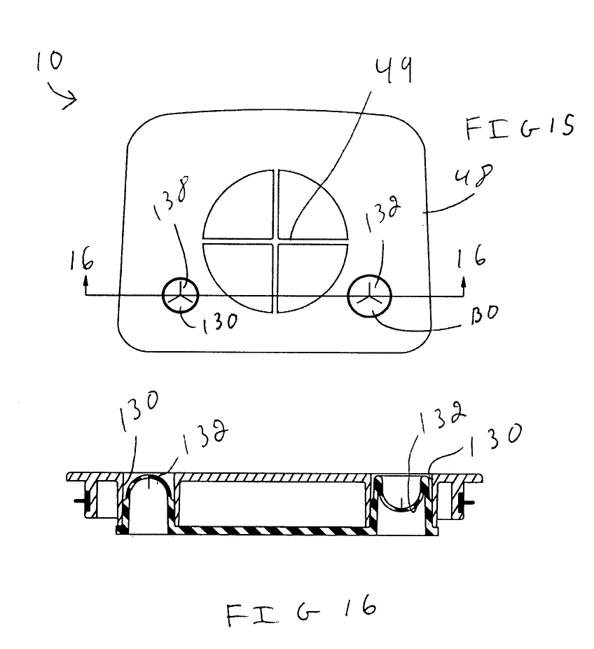

As seen in FIGS. 13 and 14, in some embodiments of the invention, the fluid dispenser 10 is usable in combination with a stand 140. The stand 140 defines a base 142 from which feet 144 extend. A dispenser attachment 146 is located in the substantially spaced apart relationship relatively to the base 142. To that effect, spacing segments 148 extend between the base 142 and the dispenser attachment 146. The dispenser attachment 146 is shaped complementarily to the bottom portion of the fluid dispenser 10 so that the fluid dispenser 10 can be removably slidably attached to the dispenser attachment 146. A recess is defined between the base 142 and the dispenser attachment 146 so that the recipient can be provided thereinto for receiving the fluid 27 from the output nozzle 110.

FIG. 15 illustrates the vent holes 130. The vent holes 130 include a pair of one-way valves 132 installed each in a corresponding aperture extending through the upper portion of fluid reservoir 26. For example, the one-way valves 132 each allow one of air admission into or air expulsion from the fluid reservoir 26. The one-way valves 132 have a structure substantially similar to the above-described structure of the output nozzle 110.

Although the present invention has been described hereinabove by way of preferred embodiments thereof, it can be modified, without departing from the spirit and nature of the subject invention as defined in the appended claims.

What is claimed is:

1. A fluid dispenser for dispensing a fluid, said fluid dispenser comprising:
a main body, said main body defining a fluid reservoir for containing said fluid;
a measuring reservoir;
an output nozzle for selectively dispensing said fluid contained in said measuring reservoir;
a valve in fluid communication with said fluid reservoir, said measuring reservoir and said output nozzle, said valve being configurable between a measuring configuration in which said fluid and measuring reservoirs are in fluid communication with each other and a dispensing configuration in which said measuring reservoir and said output nozzle are in fluid communication with each other;
a valve actuator for selectively configuring said valve between said dispensing and measuring configurations;
a piston mounted inside said measuring reservoir for reciprocating movement relative thereto between a piston first position and a piston second position, said piston substantially sealingly engaging said measuring reservoir; and
an actuating arm pivotally mounted to said main body so as to be pivotable between an arm first position and an arm second position, said actuating arm being operatively coupled to said piston such that when said actuating arm is in said arm first position, said piston is in said piston first position, and when said actuating arm is in said arm second position, said piston is in said piston second position.

2. A fluid dispenser as defined in claim 1, further comprising an actuating handle operatively coupled to said actuating arm for moving said actuating arm between said arm first and second positions.

3. A fluid dispenser as defined in claim 2, further comprising a pivot support extending from said fluid reservoir, said actuating handle defining an actuating handle proximal end and a substantially opposed actuating handle distal end, said actuating handle being pivotally coupled to said pivot support substantially adjacent said actuating handle distal end.

4. A fluid dispenser as defined in claim 3, wherein said actuating handle proximal end is further away from said pivot support than said piston.

5. A fluid dispenser as defined in claim 3, wherein said actuating handle and said actuating arm are substantially jointly pivotable about said pivot support.

6. A fluid dispenser as defined in claim 5, wherein said piston defines a piston rod protruding outwardly from said measuring reservoir, said piston actuator further including a connecting rod extending between said piston rod and said actuating arm, said connecting rod being pivotally coupled to both said piston rod and said actuating arm.

7. A fluid dispenser as defined in claim 1, wherein said valve includes a valve housing extending between said fluid reservoir and said measuring reservoir, said valve housing further protruding away from said measuring reservoir and leading to said output nozzle.

8. A fluid dispenser as defined in claim 7, wherein said fluid reservoir and said measuring reservoir extend in a substantially parallel and substantially spaced apart relationship relatively to each other.

9. A fluid dispenser as defined in claim 7, wherein said valve housing defines an intake port portion in fluid communication with said fluid reservoir, a valve stem housing portion in fluid communication with said intake port portion, a measuring reservoir port in fluid communication with said valve stem housing portion and an output port in fluid communication with said valve stem housing portion, said valve further including a valve stem defining a stem inner portion received in said valve stem housing portion and a stem outer portion extending from said stem inner portion and protruding from said valve housing, said stem inner portion being provided with a substantially radially extending distal ring sealingly engaging said valve housing, said stem being movable along said valve housing to configure said valve between said measuring and dispensing configurations, said distal ring sealing said output port from said intake port portion and said measuring reservoir port when said valve in said measuring configuration, said distal ring sealing said intake port portion from said output and measuring reservoir ports when said valve is in said dispensing configuration.

10. A fluid dispenser as defined in claim 9, wherein said valve housing defines an abutment shoulder protruding thereinto at a location intermediate said intake port portion and said measuring reservoir port.

11. A fluid dispenser as defined in claim 10, further comprising a substantially radially extending proximal ring extending from said stem inner portion substantially axially spaced apart from said distal ring.

12. A fluid dispenser as defined in claim 11, wherein said valve stem housing portion defines an abutment end plate located substantially opposed to said intake port portion, said proximal ring abutting against said abutment end plate when said valve is in said measuring configuration.

13. A fluid dispenser as defined in claim 9, further comprising a biasing element operatively coupled to said valve stem for biasing said valve stem away from said intake port portion.

14. A fluid dispenser as defined in claim 1, wherein, when said valve is in said measuring configuration, said fluid and measuring reservoirs are in exclusive fluid communication with each other, and, when said valve is in said dispensing configuration, said measuring reservoir and said output nozzle are in exclusive fluid communication with each other.

15. A fluid dispenser as defined in claim 1, wherein said valve is biased toward said measuring configuration.

16. A fluid dispenser as defined in claim 1, wherein said measuring reservoir is substantially transparent.

17. A fluid dispenser as defined in claim 16, further comprising a housing cover attached to said main body and covering said measuring reservoir, said housing cover defining a window located substantially in register with said measuring reservoir.

18. A fluid dispenser as defined in claim 1, wherein said fluid dispenser is provided with indicia indicative of a volume of said fluid received in said measuring reservoir.

19. A fluid dispenser as defined in claim 1, said fluid dispenser being usable in combination with a receiving cup for receiving said fluid thereinto, said fluid dispenser defining a receiving cup support for supporting said receiving cup substantially adjacent to said output nozzle.

20. A fluid dispenser as defined in claim 1, wherein said output nozzle is provided with a one-way check valve.
